(19) United States
(12) Patent Application Publication
(10) Pub. No.: US 2008/0258661 A1
(43) Pub. Date: Oct. 23, 2008

(54) INVERTER TOPOLOGY FOR AN ELECTRIC MOTOR

(76) Inventors: James M. Nagashima, Cerritos, CA (US); Brian A Welchko, Torrance, CA (US); Peter J. Savagian, Bloomfield Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/738,918

(22) Filed: Apr. 23, 2007

(51) Int. Cl. H02P 7/06

(52) U.S. Cl. 318/400.29

(57) ABSTRACT

An inverter is provided for controlling application of voltage from a power source to a motor having a plurality of windings. The inverter includes a first set of one or more switching elements and a second set of one or more switching elements. The first and second sets of one or more switching elements are connected between a high voltage side and a low voltage side of the power source. Each of the first set of one or more switching elements is connected to one of a first set of nodes, where each of the first set of nodes is connected to a first winding end of one of the plurality of windings of the motor. Each of the second set of one or more switching elements is connected to one of a second set of nodes and each of the second set of nodes is connected to a second winding end of one of the plurality of windings.

### TECHNICAL FIELD

The present invention generally relates to electric motors, and more particularly relates to electric motor inverters.

### BACKGROUND OF THE INVENTION

In a DC-driven electric motor system, such as a hybrid system with one or more motors, the power of the system is typically increased by enlarging the motor, adding additional magnets to the motor, or boosting the available DC voltage with, for example, a conventional boost DC-DC converter. However, a larger motor requires additional space, additional magnets provide additional complexity, and boosting the available DC voltage burdens the motor with a higher current rating.

Alternatively, an inverter can be provided to obtain increased power from an electric motor system. A conventional six-switch, three-leg inverter topology can be provided to increase the power of a system which includes one or more three-phase motors where the DC link is connected across a line-to-line portion of the wye-connected three-phase motors. However, even this conventional inverter topology has limitations on the ability to increase available power and/or decrease the current rating.

Accordingly, it is desirable to provide an improved inverter topology for obtaining additional power output from a single or multi-motor system without adding complexity to the system or increasing the motor size. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

An inverter is provided for controlling application of voltage from a power source to a motor having a plurality of windings. The inverter includes a first set of one or more switching elements and a second set of one or more switching elements. The first and second sets of one or more switching elements are connected between a high voltage side and a low voltage side of the power source. Each of the first set of one or more switching elements is connected to one of a first set of nodes, where each of the first set of nodes is connected to a first winding end of one of the plurality of windings of the motor. Each of the second set of one or more switching elements is connected to one of a second set of nodes and each of the second set of nodes is connected to a second winding end of one of the plurality of windings.

### DESCRIPTION OF THE DRAWINGS

The present invention will hereinafter be described in conjunction with the following drawing figures, wherein like numerals denote like elements, and

FIG. 1 illustrates a schematic diagram of a conventional six-switch, three leg inverter topology for an electric motor system;

FIG. 2 illustrates a schematic diagram of an inverter topology for an electric motor system in accordance with a first embodiment of the present invention;

FIG. 3 illustrates a schematic diagram of an inverter topology for a dual motor system in accordance with a second embodiment of the present invention; and

FIG. 4 illustrates a schematic diagram of an inverter topology for a dual voltage source electric motor system in accordance with a third embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

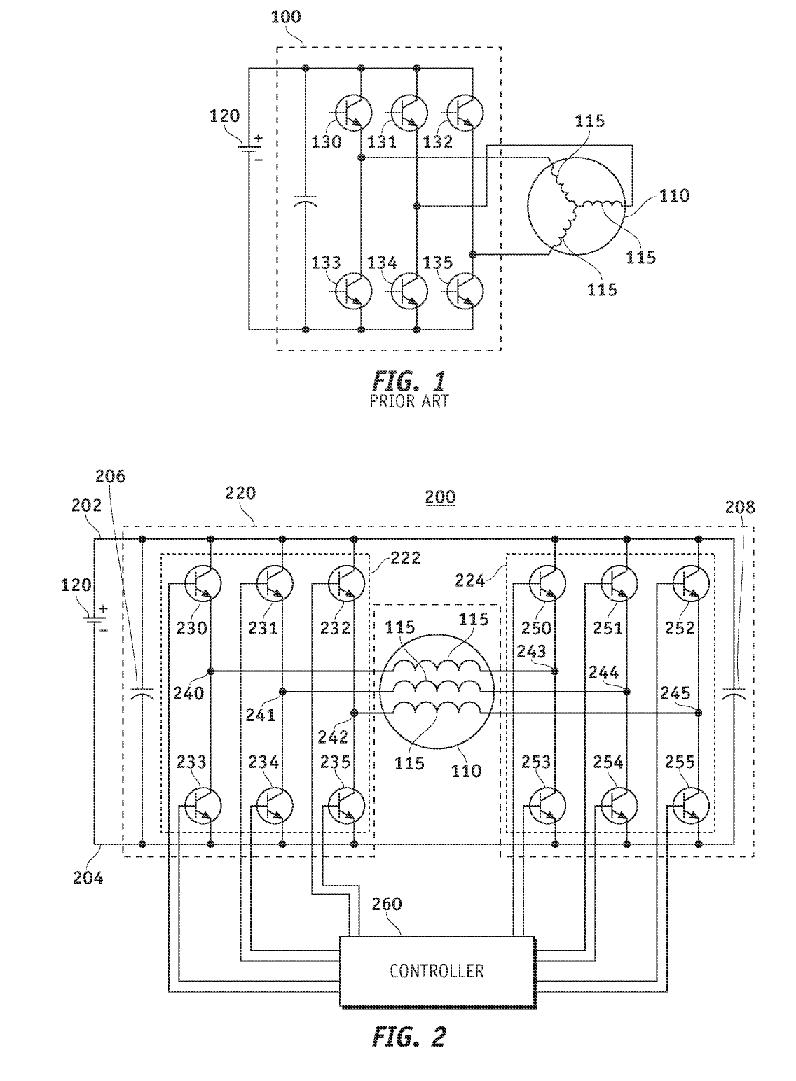

Referring to FIG. 1, a conventional inverter 100 for a wye-connected three-phase electric motor 110 is connected between lines 115 of the motor 110 and a power source 120. This conventional inverter topology utilizes a six-switch inverter 100 including transistors 130 to 135, such as Insulated Gate Bipolar Transistors (IGBT), operating in response to signals from a controller (not shown) to provide a direct current (DC) link across a line-to-line portion of the motor 110.

FIG. 2 depicts an electric motor system 200 including a six-leg inverter 220 coupled to an open end-winding three-phase alternating current (AC) motor 110 where each of a plurality of windings 115 of the motor 110 is connected across the DC link by switching elements of the inverter 220. The inverter 220 includes a first set of switching elements 222 connected between a high voltage side 202 and a low voltage side 204 of the power source 120 and a second set of switching elements 224 also connected between the high voltage side 202 and the low voltage side 204 of the power source 120. The switching elements are preferably transistors, such as IGBTs or Metal-Oxide-Semiconductor Field-Effect Transistors (MOSFETs). In addition, protective capacitors 206 and 208 are connected between the high voltage side 202 and the low voltage side 204 of the power source 120.

Transistors 230, 231, and 232 of the first set of switching elements 222 are connected between the high voltage side 202 and corresponding ones of a first set of nodes 240, 241, 242, each of the nodes 240, 241, 242 connected to a first winding end of one of the plurality of windings 115 of the motor 110. Transistors 233, 234, and 235 of the first set of switching elements 222 are connected between the low voltage side 204 and corresponding ones of the first set of nodes 240, 241, 242.

In accordance with the embodiment, transistors 250, 251, and 252 of the second set of switching elements 224 are connected between the high voltage side 202 and corresponding ones of a second set of nodes 243, 244, 245, each of the nodes 243, 244, 245 connected to a second winding end of one of the plurality of windings 115 of the motor 110. Transistors 253, 254, and 255 are connected between the low voltage side 204 and corresponding ones of the second set of nodes 243, 244, 245.

A controller 260 generates a plurality of switching signals and provides discrete ones of these switching signals to gates of each of the transistors 230 to 235 and 250 to 255 for control of the transistors 230 to 235 and 250 to 255. In accordance with the embodiment, the controller 260 provides the plurality of switching signals in a predetermined manner to activate ones of the first set 222 and the second set 224 of switching elements to increase the voltage across the windings 115. The controller produces high frequency pulse width modulated (PWM) signals designed in a manner to regulate the fundamental component of the motor phase voltage to a desired amplitude, phase, and frequency. The design of PWM signals for conventional three-phase, three-leg inverters such as depicted in FIG. 1 is well-known to those skilled in the art. Conventional PWM signaling design techniques for such three-phase, three-leg inverters may be easily extended to multiple or multi-phase inverters by those skilled in the art.

In this manner, the inverter 220 provides a higher voltage across the phases of the motor 110 than the voltage across the DC link provided by the power source 120 if inverter 100 was used. The inverter 220 has the advantage of a simple bus structure having only one DC link, while still allowing for an increased available phase voltage. Due to the single DC-link structure, the overall system requires an installed kVA of 1.15 times that of the six-switch three-leg inverter 100 of FIG. 1 to produce the same output power. However, due to the higher available phase voltage, the overall power density of the electric motor system 200 can be increased providing cost savings since it allows for an increased power out of the motor 110 without increasing the motor size. In addition, the higher available phase voltage permits the system to be designed with a lower current rating, an increased power rating, or a combination of both.

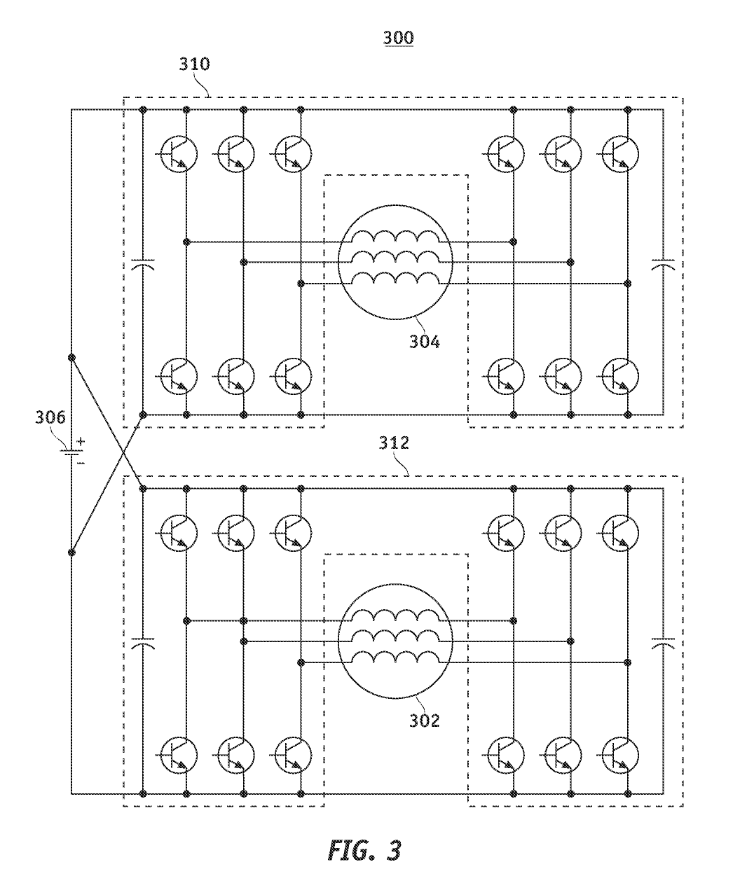

In a hybrid system with at least two motors, the power of the hybrid system can be increased by boosting the available DC voltage utilizing the six-leg inverter topology. FIG. 3 depicts an electric motor system 300 in accordance with a second embodiment and includes two motors 302, 304 powered by a single voltage source 306. A first inverter 310 provides a boosted DC-link across a first motor 302 and a second inverter 312 provides a boosted DC-link across a second motor 304. In accordance with this second embodiment, the first and second inverters 310, 312 are six-leg inverters having the topology described in detail in connection with FIG. 2.

Under the control of switching signals from a controller (not shown), the multi-motor hybrid electric motor system 300 can be operated from a single voltage source 306 and provide a higher voltage across the phases of the motors 302, 304 than would typically result in a single-power source, multi-motor system, while advantageously providing a simple bus structure.

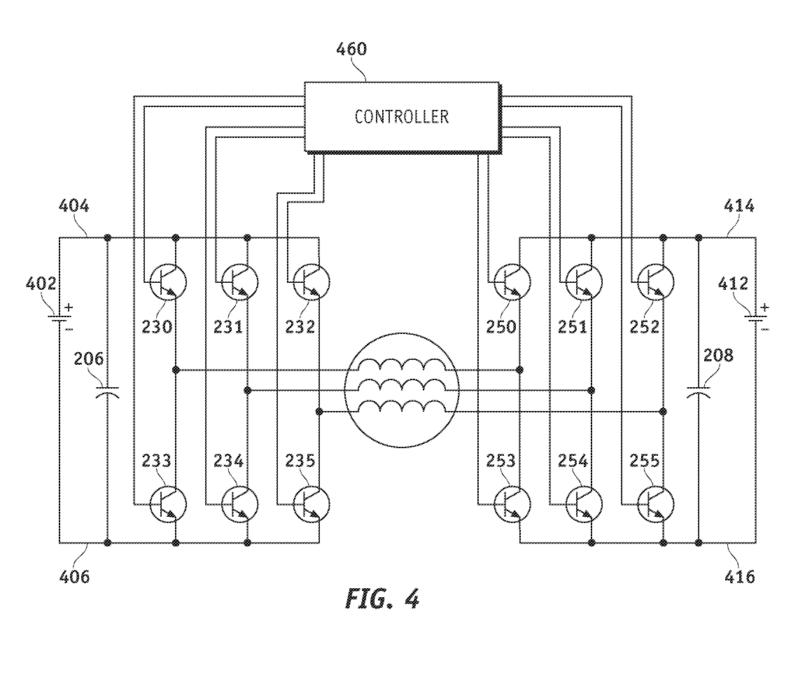

Referring to FIG. 4, a dual voltage source electric motor system 400 includes an open end-winding three-phase AC motor 110 which is powered by a first voltage source 402 and a second voltage source 412. The dual voltage sources 402, 412 could be similar power sources (e.g. batteries), or the first voltage source 402 could be a battery while the second voltage source could be a fuel cell. Switching elements 230, 231, 232, 233, 234, 235 are coupled between a high side voltage 404 and a low side voltage 406 of the first voltage source 402. Switching elements 250, 251, 252, 253, 254, 255 are coupled between a high side voltage 414 and a low side voltage 416 of the first voltage source 412. The controller 460 provides switching signals to the switching elements 230, 231, 232, 233, 234, 235, 250, 251, 252, 253, 254, 255 to provide a higher voltage across the phases of the motor 110.

In addition to the embodiments above, in accordance with the first embodiment of FIG. 2, a dual-motor, dual voltage source electric motor system could include two motor systems 200 utilizing a fuel cell to provide voltage for a first motor and a battery to provide voltage for a second motor.

While several exemplary embodiments have been presented in the foregoing detailed description, it should be appreciated that a vast number of variations exist. It should also be appreciated that the exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An inverter for controlling application of voltage from a power source to a motor having a plurality of windings, the inverter comprising:
a first set of one or more switching elements connected between a high voltage side and a low voltage side of the power source, each of the first set of one or more switching elements connected to one of a first set of nodes, each of the first set of nodes connected to a first winding end of one of the plurality of windings; and
a second set of one or more switching elements connected between the high voltage side and the low voltage side of the power source, each of the second set of one or more switching elements connected to one of a second set of nodes, each of the second set of nodes connected to a second winding end of one of the plurality of windings.

2. The inverter in accordance with claim 1 wherein the motor is a three-phase motor comprising three windings, and wherein the first set of nodes comprises a first set of three nodes, each of the first set of three nodes connected to the first winding end of one of the three windings of the three-phase motor, and wherein the second set of nodes comprises a second set of three nodes, each of the second set of three nodes connected to the second winding end of one of the three windings of the three-phase motor.

3. The inverter in accordance with claim 2 wherein the first set of one or more switching elements comprises a first set of six switching elements, wherein a first three of the first set of six switching elements are each connected between the high voltage side of the power source and a corresponding one of the first set of three nodes, and wherein a remaining three of the first set of six switching elements are each connected between a corresponding one of the first set of three nodes and the low voltage side of the power source.

4. The inverter in accordance with claim 3 wherein the second set of one or more switching elements comprises a second set of six switching elements, wherein a first three of the second set of six switching elements are each connected between the high voltage side of the power source and a corresponding one of the second set of three nodes, and wherein a remaining three of the second set of six switching elements are each connected between a corresponding one of the second set of three nodes and the low voltage side of the power source.

5. The inverter in accordance with claim 4 wherein each of the six switching elements of the first set of one or more switching elements and the second set of one or more switching elements comprises an Insulated Gate Bipolar Transistor (IGBT).

6. The inverter in accordance with claim 4 wherein each of the six switching elements of the first set of one or more switching elements and the second set of one or more switching elements comprises a Metal-Oxide-Semiconductor Field-Effect Transistor (MOSFET).

7. The inverter in accordance with claim 1 wherein the power source comprises a first voltage source and a second voltage source, and wherein the first set of one or more switching elements is connected between a high voltage side and a low voltage side of the first voltage source, and wherein the second set of one or more switching elements is connected between a high voltage side and a low voltage side of the second voltage source.

8. An inverter for controlling application of voltage from a single voltage source to a first motor having a first plurality of windings and a second motor having a second plurality of windings, the inverter comprising:
a first set of one or more switching elements connected between a high voltage side and a low voltage side of the single voltage source, each of the first set of one or more switching elements connected to one of a first set of nodes, each of the first set of nodes connected to a first winding end of one of the first plurality of windings of the first motor;
a second set of one or more switching elements connected between the high voltage side and the low voltage side of the single voltage source, each of the second set of one or more switching elements connected to one of a second set of nodes, each of the second set of nodes connected to a second winding end of one of the first plurality of windings of the first motor;
a third set of one or more switching elements connected between the high voltage side and the low voltage side of the single voltage source, each of the third set of one or more switching elements connected to one of a third set of nodes, each of the third set of nodes connected to a first winding end of one of the second plurality of windings of the second motor; and
a fourth set of one or more switching elements connected between the high voltage side and the low voltage side of the single voltage source, each of the fourth set of one or more switching elements connected to one of a fourth set of nodes, each of the fourth set of nodes connected to a second winding end of one of the second plurality of windings of the second motor 9.
The inverter in accordance with claim 8 wherein the first motor is a first three-phase motor wherein the first plurality of windings comprises three windings, and wherein the first set of nodes comprises a first set of three nodes, each of the first set of three nodes connected to the first winding end of one of the three windings of the first three-phase motor, and wherein the second set of nodes comprises a second set of three nodes, each of the second set of three nodes connected to the second winding end of one of the three windings of the first three-phase motor.

10. The inverter in accordance with claim 9 wherein the first set of one or more switching elements comprises a first set of six switching elements, wherein a first three of the first set of six switching elements are each connected between the high voltage side of the single voltage source and a corresponding one of the first set of three nodes and a remaining three of the first set of six switching elements are each connected between a corresponding one of the first set of three nodes and the low voltage side of the single voltage source, and wherein the second set of one or more switching elements comprises a second set of six switching elements, wherein a first three of the second set of six switching elements are each connected between the high voltage side of the single voltage source and a corresponding one of the second set of three nodes and a remaining three of the second set of six switching elements are each connected between a corresponding one of the second set of three nodes and the low voltage side of the single voltage source.

11. The inverter in accordance with claim 8 wherein the second motor is a second three-phase motor and the second plurality of windings comprises three windings, and wherein the third set of nodes comprises a third set of three nodes, each of the third set of three nodes connected to the first winding end of one of the three windings of the second three-phase motor, and wherein the fourth set of nodes comprises a fourth set of three nodes, each of the fourth set of three nodes connected to the second winding end of one of the three windings of the second three-phase motor.

12. The inverter in accordance with claim 11 wherein the third set of one or more switching elements comprises a third set of six switching elements, wherein a first three of the third set of six switching elements are each connected between the high voltage side of the single voltage source and a corresponding one of the third set of three nodes and a remaining three of the third set of six switching elements are each connected between a corresponding one of the third set of three nodes and the low voltage side of the single voltage source, and wherein the fourth set of one or more switching elements comprises a fourth set of six switching elements, wherein a first three of the fourth set of six switching elements are each connected between the high voltage side of the single voltage source and a corresponding one of the fourth set of three nodes and a remaining three of the second set of six switching elements are each connected between a corresponding one of the fourth set of three nodes and the low voltage side of the single voltage source.

13. The inverter in accordance with claim 12 wherein each of the six switching elements of the first set, second set, third set and fourth set of one or more switching elements comprises an Insulated Gate Bipolar Transistor (IGBT).

14. The inverter in accordance with claim 12 wherein each of the six switching elements of the first set, second set, third set and fourth set of one or more switching elements comprises a Metal-Oxide-Semiconductor Field-Effect Transistor (MOSFET).

15. An electric motor system comprising:
a first motor including a first plurality of windings, each of the first plurality of windings having a first winding end and a second winding end;
a first set of one or more switching elements connected between a high voltage side and a low voltage side of a power source, each of the first set of one or more switching elements connected to one of a first set of nodes, each of the first set of nodes also connected to the first winding end of one of the first plurality of windings;
a second set of one or more switching elements connected between the high voltage side and the low voltage side of the power source, each of the second set of one or more switching elements connected to one of a second set of nodes, each of the second set of nodes also connected to the second winding end of one of the first plurality of windings; and
a controller coupled to each of the first set of switching elements and each of the second set of switching elements, the controller generating a plurality of switching signals and providing a discrete one of the plurality of switching signals to each of the first and second sets of switching elements for control thereof.

16. The electric motor system in accordance with claim 15 wherein the first motor is a three-phase motor comprising three windings, and wherein the first set of nodes comprises a first set of three nodes, each of the first set of three nodes connected to the first winding end of one of the three windings of the first motor, and wherein the second set of nodes comprises a second set of three nodes, each of the second set of three nodes connected to the second winding end of one of the three windings of the first motor.

17. The electric motor system in accordance with claim 16 wherein the first set of one or more switching elements comprises a first set of six switching elements, wherein a first three of the first set of six switching elements are each connected between the high voltage side of the power source and a corresponding one of the first set of three nodes, and wherein a remaining three of the first set of six switching elements are each connected between a corresponding one of the first set of three nodes and the low voltage side of the power source, and wherein the second set of one or more switching elements comprises a second set of six switching elements, wherein a first three of the second set of six switching elements are each connected between the high voltage side of the power source and a corresponding one of the second set of three nodes, and wherein a remaining three of the second set of six switching elements are each connected between a corresponding one of the second set of three nodes and the low voltage side of the power source.

18. The electric motor system in accordance with claim 15 wherein the power source comprises a first voltage source and a second voltage source, and wherein the first set of one or more switching elements is connected between a high voltage side and a low voltage side of the first voltage source, and wherein the second set of one or more switching elements is connected between a high voltage side and a low voltage side of the second voltage source.

19. The electric motor system in accordance with claim 15 wherein the power source is a single voltage source providing the high voltage side and the low voltage side of the power source, the electric motor system further comprising:
a second motor including a second plurality of windings, each of the second plurality of windings having a first winding end and a second winding end;
a third set of one or more switching elements connected between the high voltage side and the low voltage side of the power source, each of the third set of one or more switching elements connected to one of a third set of nodes, each of the third set of nodes also connected to the first winding end of one of the second plurality of windings; and
a fourth set of one or more switching elements connected between the high voltage side and the low voltage side of the power source, each of the fourth set of one or more switching elements connected to one of a fourth set of nodes, each of the fourth set of nodes also connected to the second winding end of one of the second plurality of windings.

20. The electric motor system in accordance with claim 15 wherein the controller provides the plurality of switching signals in a predetermined manner to activate ones of the first and second sets of switching elements to increase the voltage across the first plurality of windings.
